(19) United States
(12) Patent Application Publication
(10) Pub. No.: US 2025/0084966 A1
(43) Pub. Date: Mar. 13, 2025

(54) Bearing for Pressure Vessel and Pressure Vessel Assembly

(71) Applicant: Bayerische Moroten Werke Aktiengesellschaft, Muenchen (DE)

(72) Inventors: Timo GUTMANN, Bad Kohlgrub (DE); Eric HENDEL, Frickenhausen (DE); Klaus SZOUCSEK, Zirndorf (DE)

(21) Appl. No.: 18/292,673

(22) PCT Filed: Jul. 20, 2022
(86) PCT No.: PCT/EP2022/070396

§ 371 Date: Jan. 26, 2024

(30) Foreign Application Priority Data
Jul. 28, 2021 (DE) 10 2021 119 603.5

(51) Int. Cl. F17C 13/08; F17C 13/02

(52) U.S. Cl. CPC F17C 13/084; F17C 13/02; F17C 2205/013; F17C 2205/0192; F17C 2223/036; F17C 2250/0469

(57) ABSTRACT

A bearing for one or a plurality of pressure vessels configured to store gaseous fuel includes at least one bearing plate per pressure vessel and a mounting. The bearing plate on an inside has a clearance configured to pass through a longitudinal end of the pressure vessel, and on an outside has a periphery configured to receive a mounting. The mounting has a first part and a second part. The second part is fastened to the first part. The periphery or the peripheries of the bearing plates is/are received in one or a plurality of intermediate spaces between the first part and the second part. The bearing plates are convex in such a way that, when viewed in a longitudinal direction of the pressure vessel, the clearance is displaced in comparison to the periphery.

### BACKGROUND AND SUMMARY

The technology disclosed herein relates to a bearing for one or a plurality of pressure vessels for storing gaseous fuel, and to a pressure vessel assembly having a plurality of pressure vessels and at least one such bearing.

Pressure vessels are used, for example, to store gaseous fuel such as hydrogen or natural gas. Pressure vessels can be used, for example, in motor vehicles or other mobile or else stationary units. Because pressure vessels may be subjected to changes in length, depending on parameters such as, for example, internal pressure or temperature, it can be advantageous to take this into account in the design of bearings at least for some applications.

Document DE 10 2017 214 077 A1 discloses a motor vehicle having a pressure vessel for storing fuel, and at least one connection element for fastening the pressure vessel to a body of the motor vehicle.

Document WO 2013/083159 A1 discloses a container for storing and transporting a pressure vessel for compressed natural gas.

Document DE 10 2017 006 715 A1 discloses a device for forming a mount for an in particular cylindrical component which extends along a longitudinal axis.

Document WO 2017/145058 A2 discloses a pressure vessel having a gas-tight liner and a reinforcement layer of composite material.

Document EP 2 669 567 A1 discloses a device for receiving and mounting a vessel, and a mounting assembly and the use thereof.

Document U.S. Pat. No. 2,540,818 discloses a device for supporting regulators for dispensing liquefied natural gas.

It is a preferred object of the technology disclosed herein to minimize or to eliminate at least one disadvantage of a previously known solution, or to propose an alternative solution. It is in particular a preferred object of the technology disclosed herein to provide a bearing for a pressure vessel which can compensate for changes in length in a simple manner, and/or enables a similar configuration of floating bearings and fixed bearings. Further preferred objects may be derived from the advantageous effects of the technology disclosed herein. This and other objects are achieved by the subject matter of this disclosure.

The technology disclosed herein relates to a bearing for one or a plurality of pressure vessels for storing gaseous fuel, comprising (i) at least one bearing plate per pressure vessel, wherein the bearing plate on the inside has a clearance for passing through a longitudinal end of the pressure vessel, and on the outside has a periphery for receiving in a mounting; and (ii) a mounting which has a first part and a second part, wherein the second part is fastened to the first part, and wherein the periphery or the peripheries of the bearing plates is/are received in one or a plurality of intermediate spaces between the first part and the second part. A particularly advantageous fastening can be achieved by means of such a bearing, wherein different fastening possibilities may also be used. In particular, a design embodiment as a floating bearing and as a fixed bearing is possible in a simple manner by means of such a bearing.

A bearing plate can in particular be understood to be a planar or convex plate. The latter may have a constant thickness, for example. However, a non-constant thickness is also possible. A longitudinal end of a pressure vessel is typically an end which is configured along a longitudinal extent of the pressure vessel. Such a longitudinal extent may be, for example, a symmetry axis of the pressure vessel. The longitudinal axis can be transverse to a cross section of the pressure vessel, for example. The first part and the second part of the mounting can in particular be fastened in such a way that they are releasable from one another. This permits easy assembling and also easy removal, for example for maintenance purposes. In the assembled state, the intermediate spaces herein are defined between the first part and the second part. The intermediate spaces can be configured so as to be complementary to the respective bearing plates, for example.

The clearance can in particular bear in an encircling manner on a respective pressure vessel. The pressure vessels are in particular to be considered external to a bearing, i.e. the bearings are configured to interact with pressure vessels. One mounting can in particular also form a plurality of bearings, thus in particular receive a plurality of bearing plates.

When viewed in the longitudinal direction of the pressure vessel, the clearance is displaced in comparison to the periphery. The bearing plate herein is in particular embodied as a convex plate. This permits additional space to be provided in comparison to a flat bearing plate. The clearance herein, in comparison to the periphery, can in particular be displaced in a direction in which the longitudinal end of the pressure vessel points. As a result, additional installation space for the pressure vessel can be provided to the extent that the additional space can be used for storing gaseous fuel. This will typically mean that the clearance is displaced outward in comparison to the periphery, wherein the term “outward” can in particular be understood to mean that the clearance is displaced in a direction which points away from the pressure vessel lying inside.

According to an embodiment, the bearing plate can be embodied to be flat at least between the periphery and the clearance. This permits a simple embodiment in which the provision of additional installation space can be dispensed with, for example.

The bearing plate can be embodied to be flat and/or without a kink, in particular on the periphery. This can also be combined with a convex embodiment. For example, the stability can be increased by the flat embodiment on the periphery, and a transition toward a mounting can be simplified.

The bearing can be embodied as a fixed bearing, for example. The embodiments of a bearing plate described so far can be used for this purpose, for example. A fixed bearing typically serves to ensure a defined relative positioning of the mounting in relation to a received end of a pressure vessel. This can be used, for example, to connect connectors such as charging and/or discharging lines at this end, for which a defined relative positioning can be advantageous.

According to an embodiment, the bearing plate has a plurality of fingers which extend from the periphery toward the clearance and have a respective free end at the clearance. According to an alternative embodiment, the bearing plate has a plurality of fingers which extend from the clearance toward the periphery and have a respective free end at the periphery. A significantly increased deflection capability of the bearing plate can be achieved in a simple manner by means of fingers of this type. Such a deflection capability can in particular be used for the embodiment of the bearing as a floating bearing. In this way, for example, longitudinal tolerances which result in the event of temperature changes or changes in the filling level can be compensated for in a particularly advantageous way. The fingers are typically connected to one another at an end opposite the free end.

According to an embodiment, disposed on at least one bearing plate is at least one deflection measurement device for measuring a deflection of the bearing plate. The deflection measurement device can in particular measure a deflection of the bearing plate. Data which may pertain to the internal pressure and/or filling level, for example, can be obtained based thereon. The deflection measurement device can in particular have an evaluation device which, based on a measured deflection of the bearing plate, is configured to calculate an internal pressure and/or filling level of a pressure vessel held by the bearing plate. Such an internal pressure and/or filling level can be used for calculating ranges or for monitoring a charging procedure, for example.

The deflection measurement device can have, for example, one or a plurality of strain gauges which are wired to one or a plurality of trimming resistors so as to form a Wheatstone bridge. This may be a quarter bridge, for example. The latter can have, for example, two such strain gauges, or else one strain gauge with corresponding pickups may be used. Trimming resistors can in particular be used as a reference within the Wheatstone bridge.

An externally encircling retaining ring can in particular be attached to the bearing plate. This retaining ring can in particular be fastened to the bearing plate in such a manner that the former does not cause any axial stiffening of the bearing plate. For example, the retaining ring can be fastened to the bearing plate by latching cams. The evaluation device can in particular be fastened to the retaining ring.

The second part can in particular be releasably fastened to the first part. Easy assembling and easy releasability for maintenance or for replacing components can be ensured as a result. The releasability can be achieved, for example, by the use of threaded connections or clamping connections.

The periphery can be circular, for example. This permits a simple embodiment which can be independent of potential twisting of a bearing plate, for example.

The mounting on the intermediate spaces can have, for example, one or a plurality of grooves for receiving the bearing plate. The grooves can be embodied as interruptions, for example. A bearing plate can advantageously be held in a form-fitting manner as a result. Exact positioning of the bearing plate can be ensured in a simple manner as a result, for example.

The first part and the second part can in particular be mutually separated along a separation plane. The separation plane can in particular be transverse or parallel to the plate plane. This permits a simple embodiment.

The technology disclosed herein furthermore relates to a pressure vessel assembly comprising a plurality of pressure vessels, wherein the pressure vessels are disposed so as to be mutually parallel. The pressure vessel assembly has a bearing as described herein, which is configured as a fixed bearing and holds the first longitudinal end of the pressure vessels; and/or the pressure vessel assembly has a bearing as described herein, which is configured as a floating bearing and holds the second longitudinal end of the pressure vessels. In terms of the bearing, all embodiments and variants described herein in the context of an embodiment as a fixed bearing or floating bearing can be applied. By using a bearing as described herein on both sides, the embodiment of a bearing described herein can be used on both sides, whereby a fixed bearing and a floating bearing can be combined. A respective pressure vessel is fixedly held in terms of its orientation on one side. A compensation of potential changes in length is enabled on the opposite side. First and second longitudinal ends can in particular be configured at opposite axial ends of the pressure vessel.

Alternatively, a pressure vessel assembly can also have a plurality of pressure vessels which can in particular be disposed so as to be mutually parallel, and a bearing described herein, which can be configured as a floating bearing and can hold two of the longitudinal ends of the pressure vessels. This can be used independently of the embodiment of fixed bearings.

In other words, a fixed bearing function, for example, can be implemented by a rigid metal plate which is clamped in a groove at a longitudinal end of a pressure vessel. A receptacle divided into two for a plurality of vessels can be used here, the receptacle comprising the external diameter of the plate and being able to be connected by threaded connections. The mounting can be fixed to the body, for example. This receptacle concept can be assembled in a very time-efficient way. The receptacle can be divided by way of the diameter of the plate, or in the plate plane. Moreover, the plate can be molded so as to form a rotationally symmetrical deep-drawn part which allows the receptacle to be moved closer to the pole cap of the vessel. This can lead to an efficient utilization of installation space at the same material input and offer greater stiffness. Likewise, a floating bearing function can be generated when the rigid metal plate is replaced by a metal plate having an integrated finger geometry with an interruption to the adjacent finger. The finger geometry can generate less stiffness in the axial direction while maintaining a sufficiently great residual stiffness in the radial direction. The fingers can be embodied from the outside to the inside, for example having an uninterrupted outer ring, as well as from the inside to the outside, for example having an uninterrupted inner ring.

The technology disclosed herein can in particular be used to embody pressure vessels, or pressure vessel assemblies, in such a way that they can advantageously be installed in flat installation spaces and with a good utilization of space. This can be used, for example, to provide pressure vessel assemblies in underfloor installation spaces of motor vehicles, which can be located below passenger cabins, for example. This facilities in particular the integration of pressure vessel assemblies in installation spaces that can in particular also be utilized in parallel for an alternative use as an installation space for electric power accumulator cells.

An internal pressure in a pressure vessel can be measured, for example by means of a pressure sensor in a connected line. This can be performed in particular when charging and/or when the vessel valves are opened. Subsequently, a momentary pressure can be calculated with the aid of a tank pressure module when the valves are closed and temperature is measured continuously.

In the integration of an elongation sensor described herein, for example in a plate bearing (floating bearing), which measure the axial longitudinal elongation of a pressure vessel, measuring during operation can also be achieved. This can minimize measuring errors, for example, and provide reliable information pertaining to an internal pressure of a pressure vessel even in the event of an accident. The longitudinal elongation is typically directly proportional to the internal pressure prevalent in the vessel. The elongation measurement can be performed, for example, by means of strain gauges which are adhesively bonded to the spring plate and can be wired to trimming resistors so as to form a quarter bridge. Trimming resistors of this type and electronic components for low-pass filtering, amplification, analog-to-digital conversion and signal processing can be integrated in a sensor housing. The sensor housing can be embodied as a plastic injection-molded part and can be plugged onto, supported on and latched to a spring plate. The strain gauge can be completely encapsulated. The sensor housing can be sealed in such a way that protection class IP67 is met, for example. The measure elongation value can be transmitted digitally to the KVA control apparatus by way of the plug interface located on the sensor housing.

The technology disclosed herein relating to a pressure vessel or pressure vessel assembly can be used in particular for a motor vehicle (e.g. passenger motor vehicles, motorcycles, commercial vehicles). The pressure vessels serve in particular to store fuel which is gaseous at ambient conditions. For example, use is possible in a motor vehicle which is operated with compressed natural gas (also referred to as CNG) or liquefied natural gas (also referred to as liquid natural gas or LNG) or with hydrogen. The pressure vessel can be fluidically connected to at least one energy converter which is specified to convert the chemical energy of the fuel into other forms of energy.

A pressure vessel can in particular be configured as a composite overwrapped pressure vessel. The pressure vessel can be, for example, a cryogenic pressure vessel or a high-pressure gas vessel.

High-pressure gas vessels are configured to permanently store fuel at a nominal working pressure (also referred to as NWP) of at least 350 bar (gauge) (=positive pressure in relation to the atmospheric pressure), or at least 700 bar (gauge), at ambient temperatures. A cryogenic pressure vessel is suitable for storing the fuel at the aforementioned working pressures even at temperatures which are significantly (for example more than 50 K or more than 100 K) below the operating temperature of the motor vehicle.

The pressure vessels can in particular be grouped so as to form a pressure vessel assembly and, conjointly with supporting, fastening and/or protecting elements (for example protective shields, screens, barrier layers, covers, coatings, wrappings, etc.) form a permanently connected unit. The latter can in particular be able to be assembled in the underfloor region below the passenger cabin. The longitudinal axes of the pressure vessels in the installed position can run so as to be mutually parallel, and/or individual pressure vessels can in each case have a length-to-diameter ratio with a value between 4 and 200, preferably between 5 and 100, and particularly preferably between 6 and 50.

The pressure vessels of the pressure vessel assembly can have a common distributor pipe. An electrically activatable shut-off valve, which is closed when non-energized and is specified to block the pressure vessel assembly, or the distributor pipe, in relation to the other fuel-conducting lines of the fuel supply system leading to the energy converter, can be provided on this distributor pipe, for example. This shut-off valve can have the function of an on-tank valve of a conventional pressure vessel. Only one shut-off valve which is closed when non-energized is expediently provided. The shut-off valve can be able to be screwed directly onto or into the pressure vessel assembly, or the distributor pipe, for example. The shut-off valve is the first valve provided downstream of each of the pressure vessels connected to the common distributor pipe. A burst-pipe protection, also referred to as an excess flow valve, can be provided on each pressure vessel, or on the distributor pipe. The distributor pipe can in particular enable at any time an equalization of pressure between the pressure vessels which is not restricted by the valves. Pressure differences are avoided as a result, and a uniform expansion of the pressure vessels in the event of changes in pressure is achieved.

The technology disclosed herein will now be described by means of the figures, in which:

### BRIEF DESCRIPTION OF THE DRAWINGS

FIG. 1 shows a pressure vessel assembly;

FIG. 2 shows a sectional view from FIG. 1;

FIG. 3 shows a pressure vessel assembly;

FIG. 4 shows a sectional view from FIG. 3;

FIG. 5 shows a pressure vessel assembly;

FIG. 6 shows a sectional view from FIG. 5;

FIG. 7 shows a bearing plate of the embodiment of FIG. 5;

FIG. 8 shows an alternative bearing plate;

FIG. 9 shows a bearing plate having an evaluation device;

FIG. 10 shows the bearing plate of FIG. 9 in a different view;

FIG. 11 shows an evaluation circuit; and

FIG. 12 shows a sectional view of an evaluation device.

### DETAILED DESCRIPTION OF THE DRAWINGS

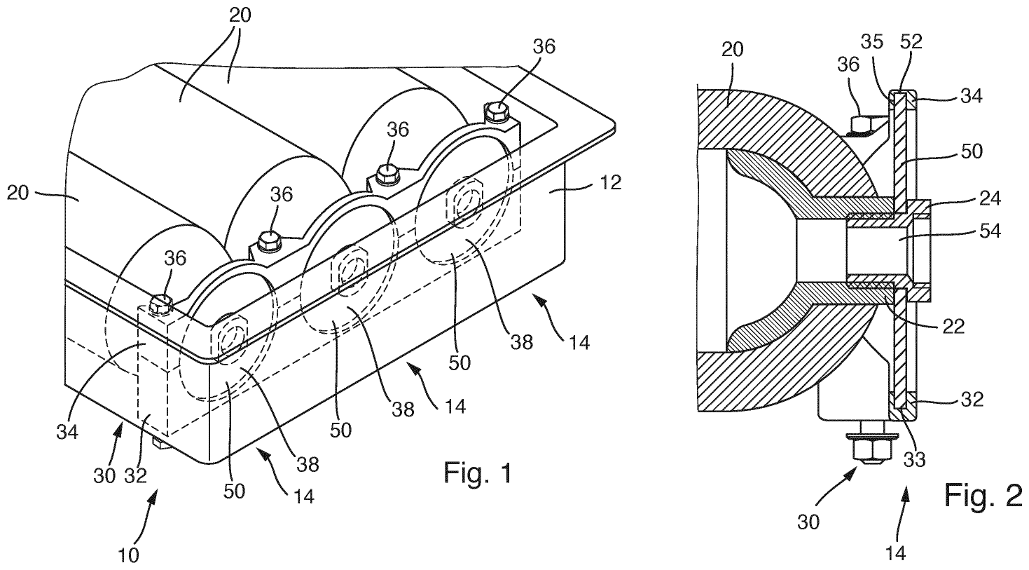

FIG. 1 shows a pressure vessel assembly 10 having a total of three pressure vessels 20, the longitudinal axes of the latter being disposed so as to be mutually parallel. The pressure vessels 20 are located in a housing 12 which encloses the pressure vessel assembly 10.

Disposed in the housing 12 is a mounting 30 which is divided into a first part 32 and a second part 34. The first part 32 herein is disposed on the lower side, and the second part 34 is disposed on the upper side. The two parts 32, 34 are screwed to one another by means of a plurality of threaded connections 36 in such a way that the two parts 32, 34 are reliably held on one another but can also be easily released.

A total of three intermediate spaces 38, which are round and each receive one bearing plate 50, are configured between the parts 32, 34. The bearing plates 50 here are flat and hold in each case one of the pressure vessels 20. A fixed bearing 14 is implemented in this way, meaning that the pressure vessel 20 on this fixed bearing 14 cannot move relative to the mounting 30.

FIG. 2 shows a sectional view through the embodiment shown in FIG. 1. It can be seen here that a pressure vessel 20 by way of a first longitudinal end 22 is received in the bearing plate 50. For this purpose, the bearing plate 50 on the inside forms a clearance 54, the first longitudinal end 22 of the pressure vessel 20 being passed through the clearance 54. For this purpose, the pressure vessel 20 on the first longitudinal end 22 thereof has an end piece 24 in which the bearing plate 50 is received. The bearing plate 50 on the outside has a periphery 52, as a result of which the bearing plate 50 is received in a groove 33 of the first part 32 as well as in a groove 35 of the second part 34. This allows the bearing plate 50 to be mounted in a form-fitting manner.

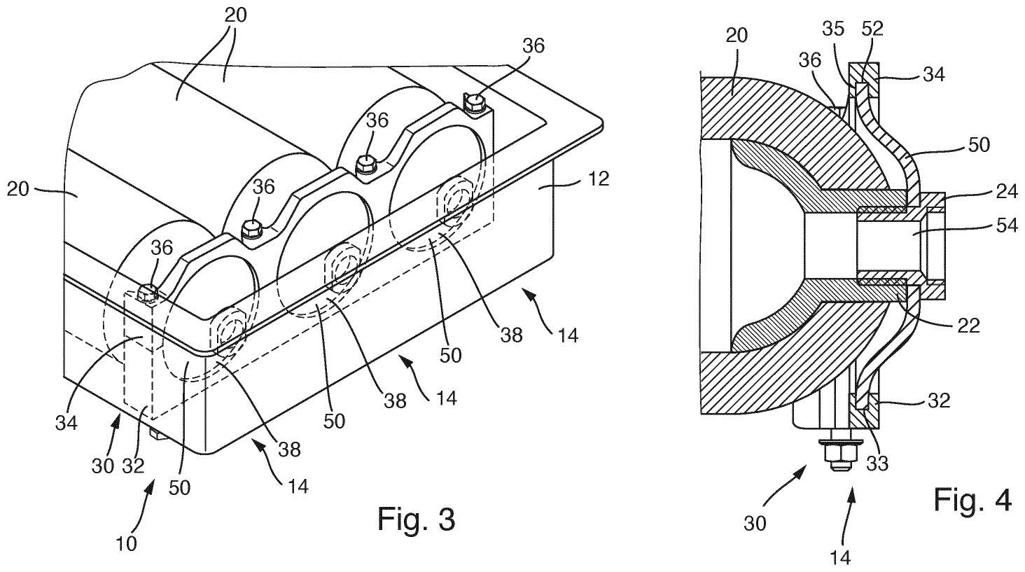

FIGS. 3 and 4 show a pressure vessel assembly according to a second exemplary embodiment, whereby the views are similar to those of FIGS. 1 and 2. In terms of elements which are not described in more detail hereunder, reference is made to the description above.

In contrast to the first exemplary embodiment, the bearing plates 50 in the embodiment according to the second exemplary embodiment are not flat but convex, so that the pressure vessel 20 can be moved further outward relative to the mounting 30. This permits a better utilization of the installation space, because the installation space to the left of the mounting 30 in FIG. 4 is better utilized for storing gaseous fuel. The convexity of the bearing plate 50 can be very readily seen in particular in FIG. 4. In terms of the overall extent of the pressure vessel assembly 10, the convexity is toward the outside.

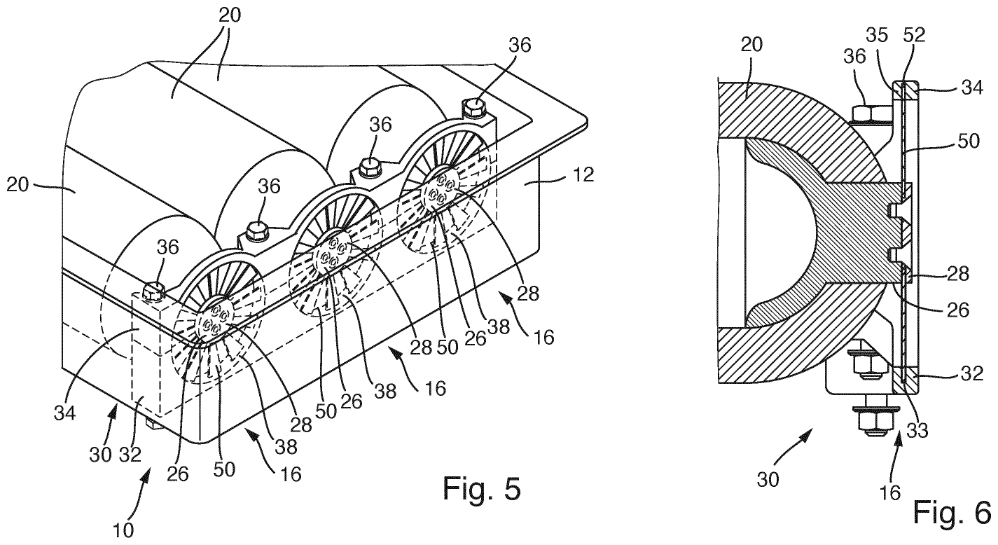

FIG. 5 shows a pressure vessel assembly according to a third exemplary embodiment. FIG. 6 shows an associated cross-sectional view. In the pressure vessel assembly according to the fifth exemplary embodiment, the bearing plates 50 are configured in such a way that the latter function as floating bearings 16. This embodiment can also be combined with the embodiments of FIGS. 1 and 2, or of FIGS. 3 and 4 on the other side.

Accordingly, a second longitudinal end 26 of a respective pressure vessel 20 is received in the bearing plate 50 by way of an associated end piece 28.

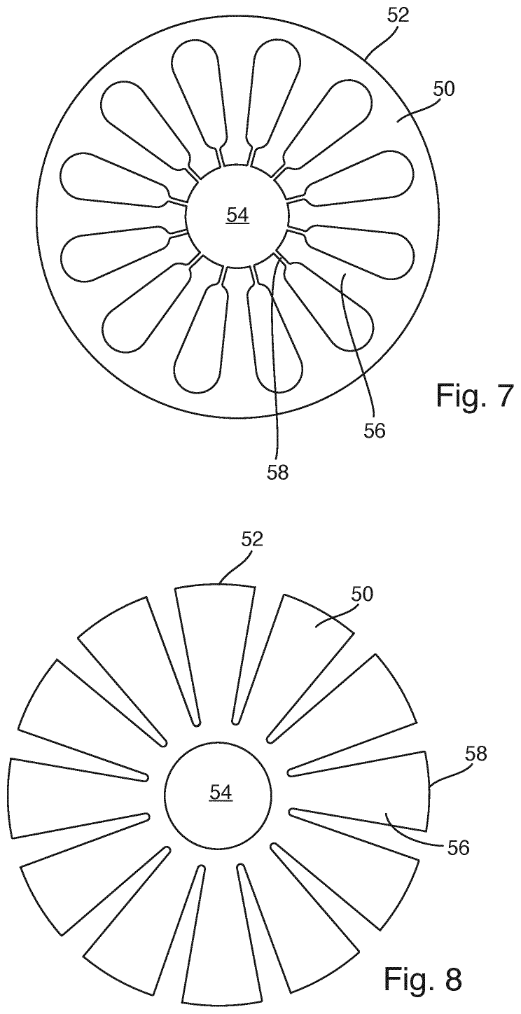

The configuration of the bearing plates 50 is illustrated in more detail in FIG. 7, which shows a frontal end view of the bearing plate 50. First to be seen is the periphery 52 on the outside. Proceeding from the periphery 52, a plurality of fingers 56 extend inward to a respective free end 58. The free end 58 is in contact with the pressure vessel 20. Achieved as a result of the configuration of the fingers 56 is a floating bearing functionality, because a significantly easier deflection capability in comparison to the bearing plate 50 without fingers is achieved. If changes in the length of a mounted pressure vessel 20 occur, the fingers 56 deflect relatively easily and in this way compensate for this change in length. Bracing stresses are avoided in this way.

FIG. 8 shows an alternative embodiment of a bearing plate 50 which can likewise be used for implementing a floating bearing. The latter can be used as an alternative in the embodiment of FIG. 5, for example. As opposed to the embodiment of FIG. 7, the fingers 56 here do not extend from the outside to the inside, but from the inside to the outside and have a respective free end 58 on the periphery 52. The same functionality can be achieved as a result.

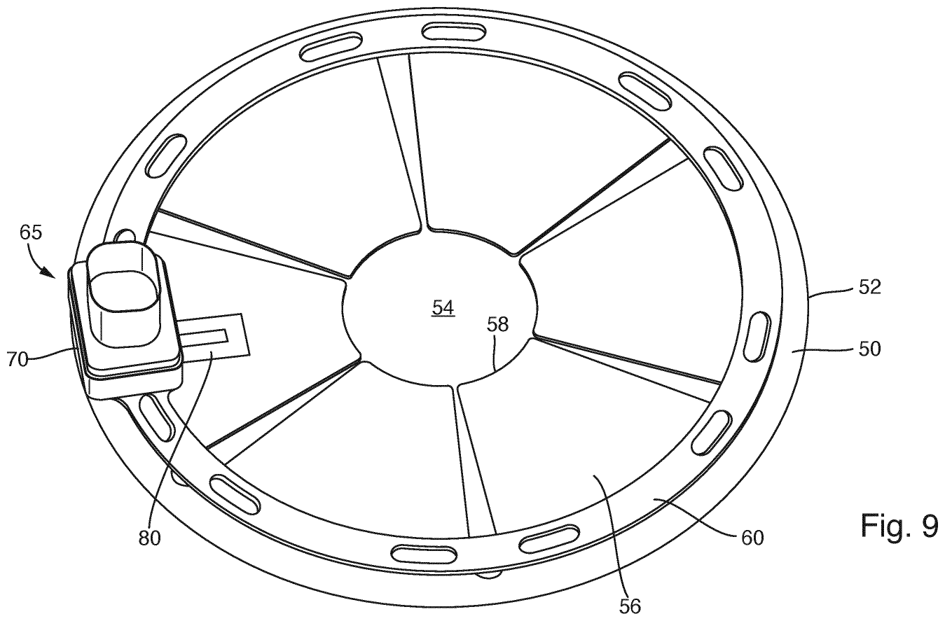

FIG. 9 shows an alternative embodiment of a bearing plate 50 having inward-extending fingers 56 and free ends 58 which are accordingly disposed on the inside, whereby a retaining ring 60 which is circumferentially encircling is additionally attached to the outside. A deflection measurement device 65 is disposed on the retaining ring 60 and on the bearing plate 50. This deflection measurement device 65 has in particular an evaluation device 70 and a strain gauge 80. The strain gauge 80 is attached to one of the fingers 56.

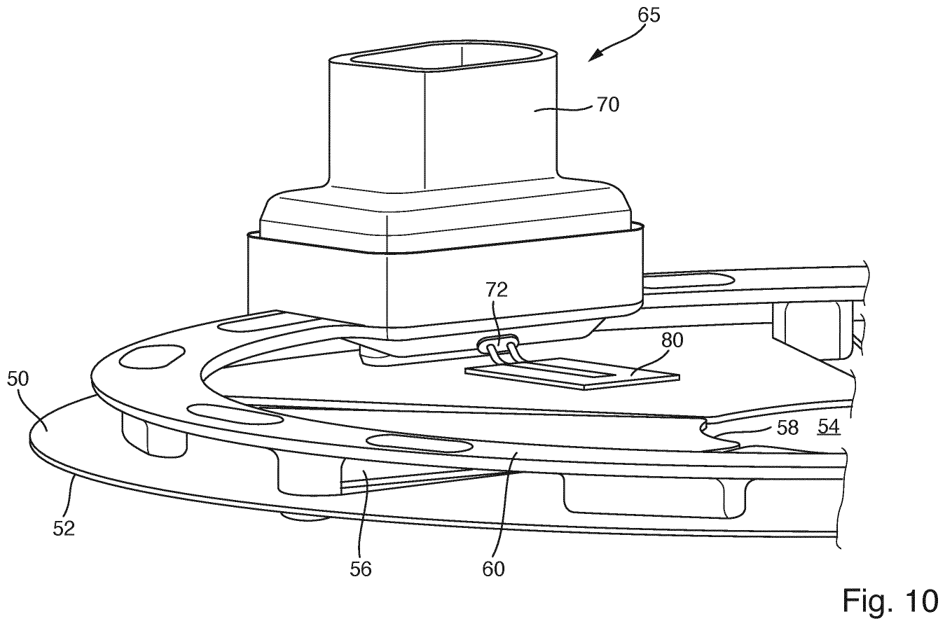

This is even more clearly illustrated in FIG. 10. The strain gauge 80 is attached in a planar manner to one of the fingers 56 and is thus conjointly deflected when the finger 56 deflects. Owing to the electrical configuration of the strain gauge 80, the latter changes its resistance in the process. The strain gauge 80 is connected to a connector 72 on the evaluation device 70. The elongation can be detected as a result, this ultimately allowing a conclusion pertaining to a change in length of the pressure vessel 20 to be drawn. This permits a calculation of the internal pressure and/or of a filling level of the pressure vessel.

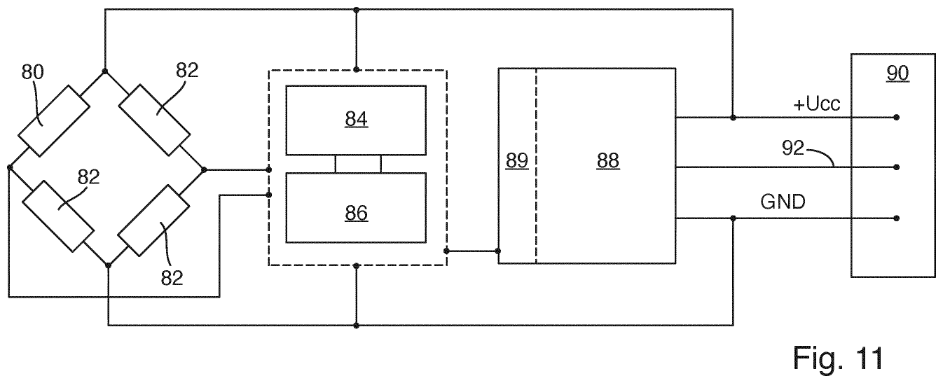

FIG. 11 shows in greater detail an evaluation circuit for evaluating the strain gauge 80. The latter is wired, as shown, to three trimming resistors 82 so as to form a Wheatstone bridge, presently a quarter bridge. A differential amplifier 84 and a low-pass filter 86, which initially ensure that the signal is processed, presently serve in the evaluation. A corresponding signal is further evaluated by a microcontroller 88 with an integrated analog-to-digital converter 89. Communication with external units can take place by way of an interface 90 which provides a supply voltage +UCC and a ground GND, and furthermore provides a digital signal line 92 by way of which data can be exchanged.

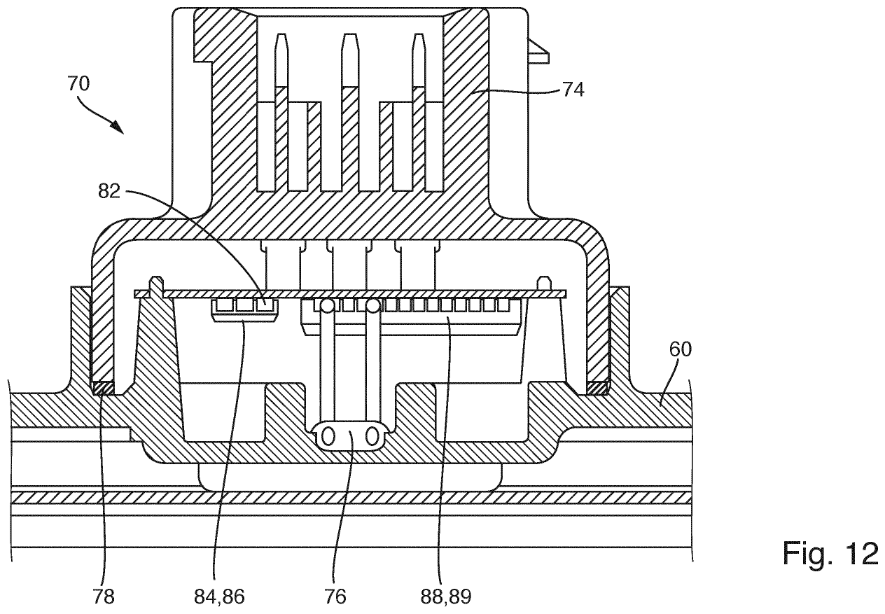

FIG. 12 shows the evaluation device 70 in greater detail. To be seen here is an exemplary positioning of the trimming resistors 82, of the differential amplifier 84, of the low-pass filter 86, of the microcontroller 88, and of the analog-to-digital converter 89. Disposed on the upper side is a plug interface 74 which can establish contact with the interface 90, for example, or can per se form the interface 90. As is shown, the evaluation device 70 is disposed in a clearance of the retaining ring 60 provided for this purpose. A profiled seal 78 serves for sealing. A cable grommet 76 serves for establishing the connection to the strain gauge 80.

It is to be understood that the embodiment described herein is only exemplary and other embodiments of such a deflection measurement device can also be used.

For reasons of legibility, the term “at least one” has occasionally been omitted for simplicity. If a feature of the technology described herein is described in the singular, or by the indefinite article (e.g. the/a pressure vessel, the/a mounting, etc.), this is intended to simultaneously also include the plurality thereof (e.g. the at least one pressure vessel, the at least one mounting, etc.).

The above description of the present disclosure serves only for illustrative purposes and not for the purpose of limiting the disclosure. Various variations and modifications are possible within the context of the disclosure without departing from the scope of the disclosure and its equivalents.

### LIST OF REFERENCE SIGNS

10 Pressure vessel assembly
12 Housing
14 Fixed bearing
16 Floating bearing
20 Pressure vessel
22 First longitudinal end
24 End piece
26 Second longitudinal end
28 End piece
30 Mounting
32 First part
33 Groove
34 Second part
35 Groove
36 Threaded connection
38 Intermediate spaces
50 Bearing plate
52 Periphery
54 Clearance
56 Finger
58 Free end
60 Retaining ring
65 Deflection measurement device
70 Evaluation device
72 Connector
74 Plug interface
76 Cable grommet
78 Profiled seal
80 Strain gauge
82 Trimming resistors
84 Differential amplifier
86 Low-pass filter
88 Microcontroller
89 Analog-to-digital converter
90 Interface
92 Signal line

1.-18. (canceled)

19. A bearing for one or a plurality of pressure vessels configured to store gaseous fuel, comprising:
at least one bearing plate per pressure vessel, wherein the bearing plate on an inside has a clearance configured to pass through a longitudinal end of the pressure vessel, and on an outside has a periphery configured to receive a mounting; and
a mounting which has a first part and a second part, wherein
the second part is fastened to the first part,
the periphery or the peripheries of the bearing plates is/are received in one or a plurality of intermediate spaces between the first part and the second part, and
the bearing plates are convex in such a way that, when viewed in a longitudinal direction of the pressure vessel, the clearance is displaced in comparison to the periphery.

20. The bearing according to claim 19, wherein the clearance is displaced in comparison to the periphery in a direction in which the longitudinal end of the pressure vessel points.

21. The bearing according to claim 20, wherein the bearing plate is configured to be flat and/or without a kink on the periphery.

22. The bearing according to claim 21, wherein the bearing is embodied as a fixed bearing.

23. The bearing according to claim 21, wherein the bearing plate has a plurality of fingers which extend from the periphery toward the clearance and have a respective free end at the clearance.

24. The bearing according to claim 21, wherein the bearing plate has a plurality of fingers which extend from the clearance toward the periphery and have a respective free end at the periphery.

25. The bearing according to claim 24, wherein the bearing is embodied as a floating bearing.

26. The bearing according to claim 25, further comprising: at least one deflection measurement device that is configured to measure a deflection of the bearing plate and that is disposed on at least one bearing plate.

27. The bearing according to claim 26, wherein the deflection measurement device has an evaluation device which, based on a measured deflection of the bearing plate, is configured to calculate an internal pressure and/or filling level of a pressure vessel held by the bearing plate.

28. The bearing according to claim 27, wherein the deflection measurement device has one or a plurality of strain gauges which are wired to one or a plurality of trimming resistors, so as to form a Wheatstone bridge.

29. The bearing according to claim 28, further comprising: an externally encircling retaining ring that is attached to the bearing plate.

30. The bearing according to claim 29, wherein the second part is releasably fastened to the first part.

31. The bearing according to claim 30, wherein the periphery is circular.

32. The bearing according to claim 31, wherein the mounting on the intermediate spaces has one or a plurality of grooves configured to receive the bearing plates.

33. The bearing according to claim 32, wherein the first part and the second part are mutually separated along a separation plane which is transverse or parallel to the plate plane.

34. A pressure vessel assembly comprising:
a plurality of pressure vessels, wherein the pressure vessels are disposed so as to be mutually parallel; and
a bearing according to one of the preceding claims, which is configured as a fixed bearing and which holds first longitudinal ends of the pressure vessels; and/or
a bearing according to claim 31, which is configured as a floating bearing and which holds second longitudinal ends of the pressure vessels.
